(19) United States
(12) Patent Application Publication
(10) Pub. No.: US 2005/0177542 A1
(43) Pub. Date: Aug. 11, 2005

(54) Account-owner verification database

(76) Inventors: Glen Sgambati, Glendale, AZ (US); Robert Perrotta, Scottsdale, AZ (US); Rich Mayo, Cave Creek, AZ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/773,642

(22) Filed: Feb. 6, 2004

(51) Int. Cl. G06F 7/00

(52) U.S. Cl. 707/1

(57) ABSTRACT

A method of populating an account-owner verification database includes collecting participant data elements from one or more participant institutions. The participant data elements are associated with one or more participant accounts in the participant institutions, and each participant data element also corresponds to a data element field in the database. Non-participant data elements are collected from one or more non-participant institutions. The non-participant data elements are associated with one or more non-participant accounts in the non-participant institutions, and each non-participant data element also corresponds to one of the data element fields in the database. The data element fields of the account verification database are populated with the collected participant and non-participant data elements.

### BACKGROUND OF THE INVENTION

Banks, merchants and other payment processing services routinely verify information related to a particular financial account. For example, payment processors and financial service companies verify checking account information for a consumer wishing to make a transaction using that account. Such transactions occur in a variety of forms, including traditional paper checks, debit cards, electronic checks or Automated Clearing House debit system transactions. With the rapid volume growth of telephone (TEL) and Internet (WEB) originated automated clearing house (ACH) transactions, verification of such account and/or identity information is becoming even more crucial.

For example, with the increase of WEB transactions, (non face-to-face transactions), efforts to identify the person conducting the transaction as an authorized user of the account is necessary to help mitigate losses from identity theft and account takeover. Because of the risk of fraudulent transactions associated with WEB purchases, a large number of retailers allow consumers to order merchandise from their WEB site but require the consumer to physically go to a store location to purchase and pick up the merchandise. Similarly, new account funding for opening deposits and subsequent bank to bank transfers, processed through financial services companies, are becoming necessary for customer convenience.

Additionally, the emergence of ACH transactions has also created a problem with administrative returns. Currently, many banks do not integrate their check processing algorithms into their ACH system, thereby contributing to the high number of administrative returns being processed.

In summary, numerous losses to merchants and/or financial institutions occur due to identity theft, counterfeiting, and account takeovers. With the rapid growth in Internet transactions and E-Check payments, fraud perpetrators can conduct fraud remotely when they want, where they want, and with no face-to-face contact. Because of the anonymity, reach and speed that the Internet provides for fraudsters, risk management and fraud prevention have become necessary components of every e-commerce infrastructure.

Known check archival services, such as ViewPointe, routinely take and store images of checks that have been paid. However, check imaging services are primarily archival in nature. Generally nothing further occurs to the checks or the information contained in the check images.

Presently, a check verification system (DEPOSIT CHEK, available from Primary Payment Systems, Inc.) exists which includes a database populated with checking account information contributed directly by participant banks or institutions. DEPOSIT CHEK provides advance notification of potential check returns to participating financial institutions by allowing financial institutions inquiry access to a national shared account and transaction database (NSD), which is contributed to by major financial institutions and updated daily, and which includes the most current checking account status information as well as check-level detail on returned items and stop payments. The information stored in the NSD and accessible via DEPOSIT CHEK is intended to be available to inquirers receiving funds by check or electronic payment in sufficient time to enable them to avoid loss that might result from non-payment. The NSD thus stores information about each participant institution's checking accounts, such that, if queried about a particular participant bank's account, the database will return the status (e.g., closed, overdrawn, high check return rate or new) of that account to the inquirer. The inquirer (such as a merchant or depository bank) may then decide whether to accept the check and/or whether to place an “extended hold” on the checking account. Inquiries may take place immediately (i.e., in real-time) or in overnight batch processes.

A major concern for DEPOSIT CHEK participants regarding WEB or electronic transactions is attempts to fraudulently debit corporate/business accounts. Therefore, it would be helpful to provide a mechanism to identify individuals attempting to use a corporate/business account prior to initiating such electronic transactions.

Check verification services also exist for situations in which information about the account in question is only available from a “non-participant” bank or institution (one which does not supply or hold account data which is guaranteed to be accurate and/or current). For example, the inquirer may consult other existing databases, call the payor institution directly, use other check verification services that obtain data from other sources, or review historical and/or statistical records for the customer that is presenting the check.

Other account verification systems include searching specific data elements from a populated database. For example, the Address Verification System (“AVS”) is a database that links credit card account numbers to the billing address of the accounts. The data contained in the AVS is provided by the credit card companies. Merchants use the AVS by submitting a credit card number and the billing address provided by the purchaser. If the address matches the address in AVS for that account, then AVS returns a positive indication that the consumer's “ship to” address is the same as the consumer's “bill to” address for that credit card, thus assisting in validating that the person is authorized to use that credit card.

Additionally, searching multiple data fields traditionally found on a check to verify account information is also known in the art. For example, a web-based system run by Paybycheck.com verifies on-line transactions paid using a checking account. Paybycheck requires the consumer to enter information about his account into designated fields within a simulated “check” presented on the screen. Paybycheck then verifies the entered data against data in the corresponding data fields stored within its database. Paybycheck then makes a determination as to whether the entered checking account information is accurate.

The accuracy and usefulness of known account verification services is directly dependant on the robustness of the information contained within the databases which those services access. For example, simply providing an inquirer with the status of the account corresponding to the check which the inquirer wants to verify does not guarantee that the consumer is actually authorized to transact on that account. Similarly, accessing the AVS for a credit card transaction only verifies the account against the known billing address, and no other information about the consumer is verified.

Thus, it would be advantageous to develop an account verification database with sufficient robustness to determine whether the person identified with the desired account is authorized to transact on that account.

### BRIEF SUMMARY OF THE INVENTION

Briefly stated, in accordance with a first aspect of the present invention, a method of populating an account-owner verification database includes the step of collecting participant data elements from one or more participant institutions, where the participant data elements are associated with one or more participant accounts in the participant institutions. Each participant data element also corresponds to a data element field in the database. Non-participant data elements are collected from one or more non-participant institutions. The non-participant data elements are associated with one or more non-participant accounts in the non-participant institutions, and each non-participant data element also corresponds to one of the data element fields in the database. The data element fields of the account verification database are populated with the collected participant and non-participant data elements.

According to a second aspect of the present invention, an account-owner verification database includes a plurality of data element fields populated with participant data elements and non-participant data elements. The participant data elements are collected from one or more participant institutions and the participant data elements are associated with one or more participant accounts in the participant institutions. The non-participant data elements are collected from one or more non-participant institutions and the non-participant data elements are associated with one or more non-participant accounts in the non-participant institutions.

According to a third aspect of the present invention, a method of verifying information associated with transacting on an account includes providing an account verification database which includes account data corresponding to a plurality of data element fields which are organized according to account number. The account data in the database is obtained from participant and non-participant institutions. For each account to be verified, an account number is entered and at least one data element corresponding to the entered account number is entered. The database is then queried. A response is received from the database for each of the entered data element(s). The response corresponding to each entered data element is positive if the account data stored in the data element field corresponding to the entered account number matches the entered data element, respectively.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a block diagram showing an account-verification database and method of populating the database in accordance with one preferred embodiment of the present invention;

FIG. 2 is a flow diagram showing an example of an account-owner verification database in accordance with one preferred embodiment of the present invention; and

FIG. 3 is a table showing an example of an inquiry to the account-owner verification database of FIG. 2.

### DETAILED DESCRIPTION OF THE INVENTION

To expand the data content captured in the NSD to further reduce payment and new account/relationship losses across multiple industries, an account-owner verification database is formed by modifying the NSD so that participants can contribute additional information related to accounts held by those participants.

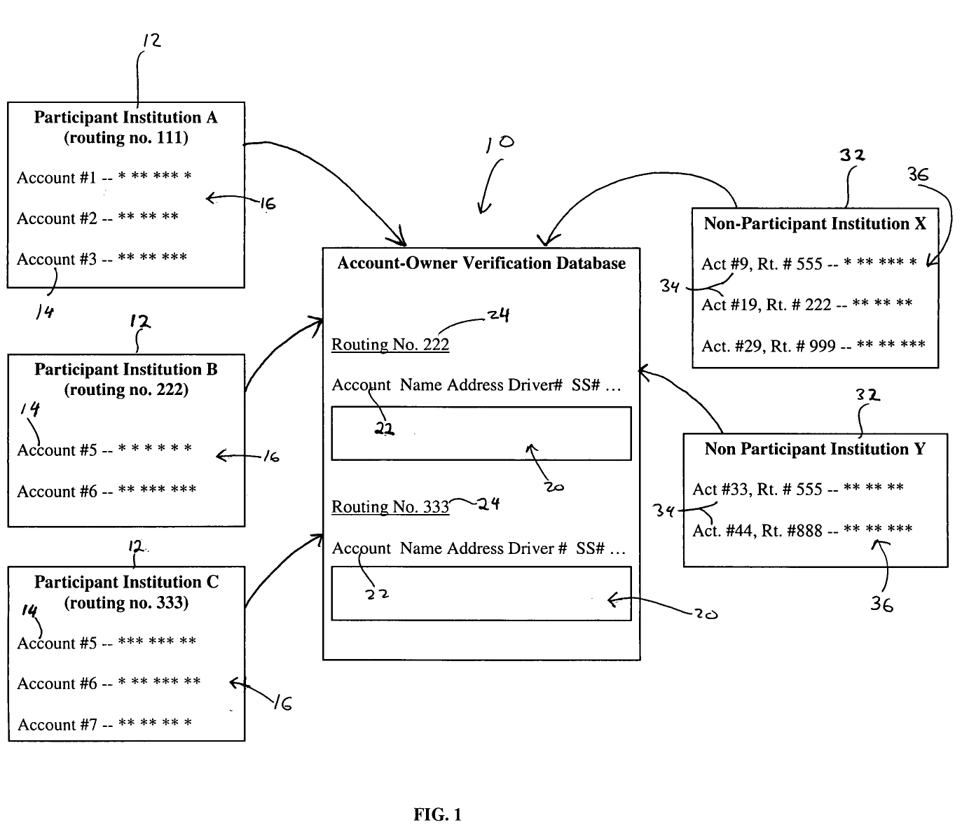

Referring to FIGS. 1-3, an account-owner verification database, generally designated 10, and a method of populating such database in accordance with the present invention is shown. The database 10 provides verification of specific accountholder information upon inquiry and is designed to be contributed to and updated on a regular basis.

The database 10 is populated by collecting participant data elements 16 from various contributing or participant institutions 12. The participant institutions 12 are preferably generally banks or other financial institutions which have agreed to continually and automatically provide current, accurate information related to participant accounts 14, in a predetermined quantity and format, to the database 10 with which to populate the database 10. The participant institutions 12 need not specifically be financial institutions, but may be other agencies, entities or institutions which have the ability to provide accurate financial account data on a regular basis.

The participant data elements 16 provided by the participant institutions 12 include information which corresponds to the individual participant accounts 14 held and/or maintained by that participant institution 12. A data element 16 is thus a piece of information associated with a participant account 14 and which helps identify the owner of that account and/or another data element of that participant account 14. Generally, a participant data element 16 for an account may be any categorized information associated with a particular account. For example, possible categories of data elements include names, addresses, dates of birth, identification/drivers' license numbers, social security numbers, tax i.d. numbers, account type, channel origination and other type of data typically associated with checking (or other) accounts.

The account-owner database 10 is populated in part by extracting and collecting data elements 16 associated with one or more participant accounts 14 from one or more participant institutions 12. The data elements 16 from a single participant institution 12 may be related to one or more participant accounts 14. That is, a participant institution 12 may populate the database 10 with data elements 16 from a single account or with data elements 16 from multiple accounts.

The account-owner database 10 according to the present invention also collects and stores non-participant data elements 36 corresponding to non-participant accounts 34 held by non-participant institutions 32. A non-participant institution 32 is an entity capable of supplying financial account information, but which is not capable of nor obligated to provide account information to the account-owner database 10 on a regular and/or automatic basis. Additionally, the information provided by a non-participant institution 32 need not be accurate. For example, non-participant institutions may have access to account information which is obtained from negative (as opposed to positive) populated databases, thereby containing information which, for example, may be triggered by only “bad events” or which is otherwise less than current. Therefore, non-participant data elements 36 may be collected from a variety of sources and are not necessarily accurate or current.

One example of a non-participant institution 32 is a check imaging service or database, such as ViewPointe. Imaging checks and reading account information therefrom is well known in the art. Therefore, a description of check imaging systems is omitted here for convenience only, and should not be considered limiting. Using such a system, non-participant data elements 36 may be obtained by extracting account information from the collected check images. Other non-participant institutions 32, and therefore sources of non-participant data elements 36, include, for example, check printers, electronic bill payment companies, WEB and TEL transacted bill payment systems, Internet account openings and Internet banking (e.g., ING, Net Bank) and other similar services. Each of these services contains at least non-participant data elements 36 which, if collected and stored in the database 10, adds to the robustness of the database 10. For example, non-participant data elements 36 may be obtained in the form of check printer data. Although not an account holding institution such as a traditional bank, a check printer nonetheless has access to accurate financial account information, albeit on a limited scale in comparison to account information available to an actual participant institution 12.

Additionally, in place of or in addition to non-participant data elements 36 comprising raw account information gathered from non-participant institutions 32, the database 10 may also be populated with non-participant data elements 36 which are based on statistically accurate or analyzed account information from non-participant institutions 32, thereby adding an additional level of accuracy to the non-participant data elements stored in the database 10. The participant data elements 16 need not be exclusively obtained through the automatic population scheme discussed above, but may also be obtained from the sources noted here for obtaining non-participant data elements 36. Furthermore, a non-participant institution 32 may transition to become a participant institution 12, assuming that all of the necessary accuracy and updating requirements are satisfied.

The account-owner verification database 10 preferably includes a plurality of data element fields 20. In the preferred embodiment, the available data element fields include: routing transit number, account number, names, addresses, dates of birth, identification/drivers' license numbers, social security numbers, tax i.d. numbers, account type, channel origination and other various data typically associated with checking (or other) accounts. Each of the data element fields 20 preferably contains a corresponding participant or non-participant data element 16, 36 obtained from a participant or non-participant institution 12, 32, respectively, as discussed above. Thus, for example, a data element (e.g., account information) which is denoted as “driver's license number” obtained from a participant or non-participant institution 12, 32 would be stored in the database 10 in the data element field 20 labeled “driver's license number”.

For each new or updated account from a participant institution 12, the participant institution 12 is required to provide sufficient participant data elements 16 to fill a minimum set of data element fields 20. In the preferred embodiment, the minimum required data element fields 20 include: routing transit number, account number, one name, one address and one social security or tax i.d. number. Other participant data elements 16 sufficient to populate less vital data element fields 20 may also be sent by the participant institution 12.

The minimum set of data element fields supplied by a participant institution 12 need not be the specific fields noted above, but rather may be adjusted according to the particular account verification application. Additionally, since non-participant institutions 32 may not have a wide array of account information, not all of the available data element fields 20 in the account-owner database 10 which are populated with participant data elements 16 are collectable for accounts related to non-participant institutions 32. For example, paper checks include limited personal information printed thereon. Thus, non-participant data elements 36 provided through non-participant institutions 32 such as check imaging systems (e.g., ViewPointe) and/or check printers simply do not have sufficient account information to populate all of the available data element fields 20 (and perhaps even the minimum set of data element fields) in the account-verification database 10. Accordingly, the database 10 may not include a full complement of non-participant data elements 36 for a given account 22. Additionally, since the non-participant data elements 36 are often not as reliable nor complete as participant data elements 16, an account 22 which includes data element fields 20 which are populated with non-participant data elements 36, are noted in the database 10 as containing data elements from non-participant institutions 32.

Since a primary goal of the account-owner verification database 10 is to determine if a person is authorized to transact on a particular account (i.e., the account number presented to the merchant), the database 10 is preferably structured such that the data element fields 20 are arranged in the database 10 according to corresponding account number 22. Since multiple participant and/or non-participant institutions 12, 32 may have the same account number 22, the individual account numbers 22 are preferably arranged within the database 10 according to routing transit number 24. However, the database 10 may be structured or organized according to other schemes without departing from the spirit and scope of the present invention, so long as the individual data element fields 20 are searchable to find the relevant data elements 16, 36 to help verify the identity of a person attempting to transact on a particular account.

Preferably, the database 10 is initially populated by the participant institutions 12 with a single file including all of the required participant data elements 16 for all of the accounts in the participant institution 12. However, once the database 10 has been initially populated, the participant data elements 16 in the database are preferably updated with new information associated with account(s) at the participant institution 12 based on newly opened and/or recently maintained accounts. More specifically, the database 10 is refreshed or updated with participant data elements 16 associated with accounts at participant institutions 12 which have been recently opened, closed, changed in status (e.g., overdrawn) or which have incurred changes to one or more of their own data elements. Preferably, the collected data elements in the database 10 are stored and updated at regular intervals Such automatic and continuous updating of the database 10 provides an inquirer with a very robust account verification tool. The database is also preferably updated in less frequent intervals with new and/or updated non-participant data elements 36 obtained from non-participant institutions 32.

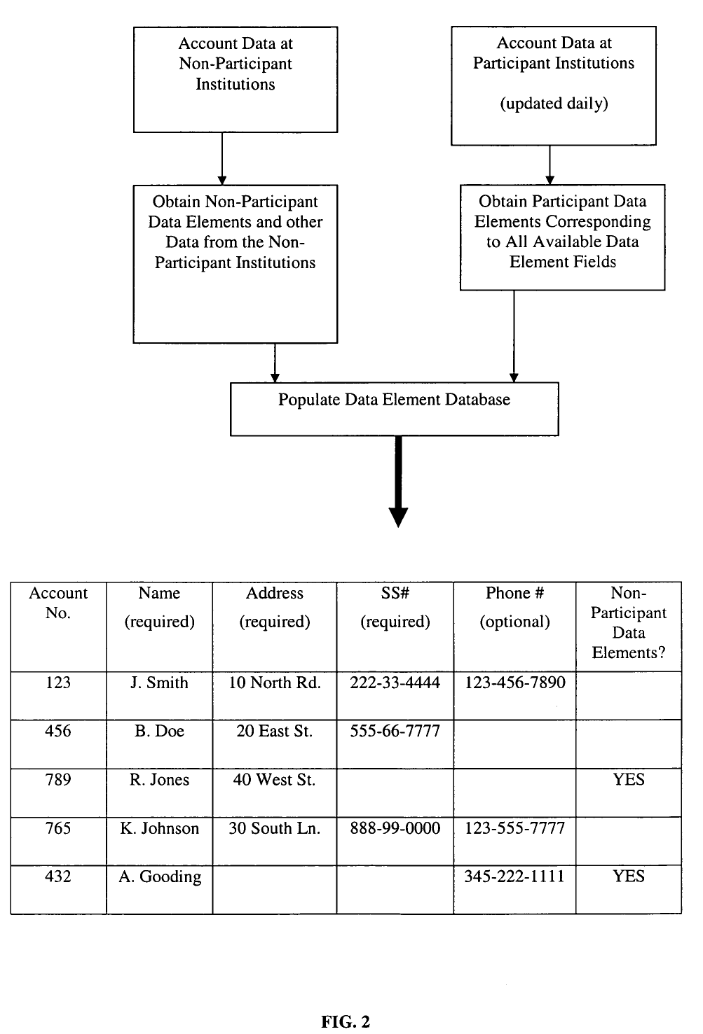

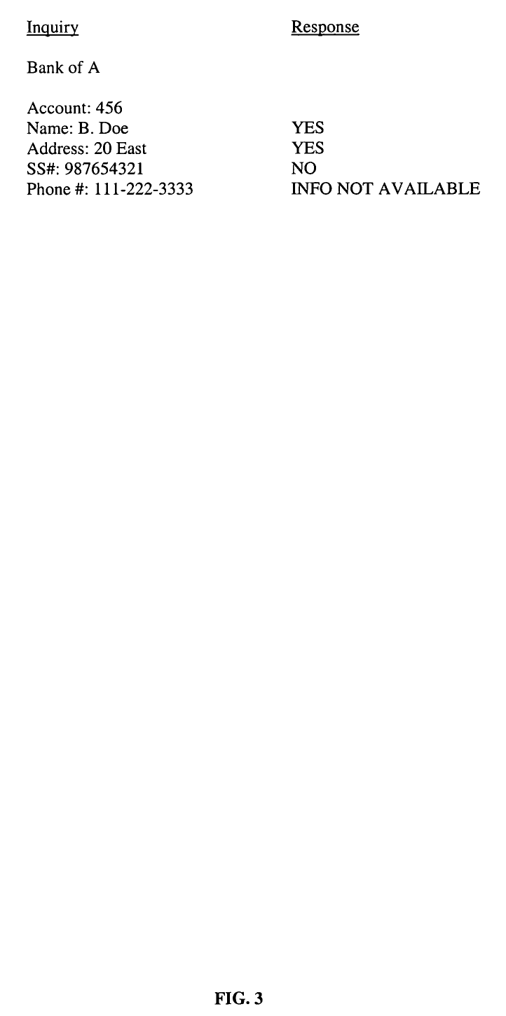

The population and inquiry of the account-owner verification database 10 will be explained through the following example, in conjunction with FIGS. 2 and 3. As shown in FIG. 2, the sample populated account-owner verification database 10 contains five different account entries. Non-participant data elements 36 for account numbers 789 and 432 were obtained from a non-participant institution 32, as denoted in the last data element field 20. Thus, not all of the required data element fields 20 for those accounts are populated.

To submit an inquiry to the account-owner database 10, an inquirer must, at the very least, provide an account number 22 and at least one other data element (purportedly corresponding to that account number) for verification. In cases where the database 10 is also organized according to routing transit number, the inquirer should also provide the routing transit number 24 which corresponds to the designated account 22. The inquirer may enter an account number and multiple data elements to be verified at once. Assuming that the requested account number is in the database 10, the entered data elements are queried against the information stored in the corresponding data element field(s) 20 associated with the entered account number 22. The database 10 returns a verification of each individual submitted data element corresponding to that account number. For each data element in an inquiry, a response of “yes,” “no” or “information not available” is returned to the inquirer, respectively. A positive, or “yes” response is received if the entered data element matches the content of the corresponding data element field 20 in the database 10 for the entered account number. Similarly, a negative, or “no” response is returned to the inquirer if the entered data element does not match the content of the corresponding data element field 20 in the database 10 for the entered account number. An “information not available” response is received if the data element field 20 in the database 10 corresponding to the entered data element is empty. The complete response received by the inquirer may contain one or more of each of the possible responses. That is, the database 10 responds according to each individual entered data element, respectively. Thus, to obtain a “positive” response, it is not required that all of the entered data elements match the contents of their corresponding data element fields for the entered account number.

Preferably, no customer-specific data is provided back to the inquirer. Rather, the database only confirms or denies the accuracy of the information as entered into the data element field which corresponds to the entered account number. An example (based on the database 10 of FIG. 2) of an inquiry and response corresponding to that inquiry according to the present invention is shown in FIG. 3.

Additionally, if an inquiry regarding a particular account results in a “NO” response on at least one data element in an inquiry, the database reports to the participant institution 12 for that account that there was an inquiry against one of their accounts which resulted in a negative response, along with the data element(s) that produced that negative response. In the example of FIG. 3, a report to Bank of A would be generated that an inquiry was made against account # 456 which produced a negative response for identified SS#.

The database 10 provides inquiry capabilities allowing inquirers to validate information about an account holder, in addition to the account's current status. The inquiry submitted to the database 10 may be made on-line, in real time or in a batch-process. Thus, the inquirer could be a major financial institution or a small business. The account-owner verification database 10 is particularly advantageous for “faceless” transactions where the identity of the account holder cannot be verified. Additionally, an inquirer can determine the status and relevant account holder information about an account in real time, such that business transactions are not delayed, while still preventing fraud on the transaction.

The account-owner database 10 is positively, or actively, populated using information that is collected from actual participant institutions 12 based on current account information. This is an advantage over existing similar databases and account verification systems which utilize negative, or passive, data based on account information which is retained based on accounts and/or checks which are known to be faulty, fraudulent or otherwise troublesome. Negatively populated databases generally contain account information for which there has been a recorded or reported problem. Since the database 10 according to the present invention utilizes a positively populated database where data elements are obtained from participant institutions 12, the status and validation of participant data elements which are returned to the inquirer are both current and timely, as opposed to being based simply on negative databases which are not populated in a standardized manner. Furthermore, since the database 10 also integrates account information from non-participant institutions 32, the database 10 according to the present invention includes an added level of robustness, thereby providing additional verification accuracy to an inquirer.

A primary benefit of the above described account-owner verification database and associated population and inquiry schemes is that inquirers may determine if the identified person is authorized to transact on the presented account. Such a feature is particularly advantageous in non face-to-face transactions, such as telephone and Internet transactions, as merchants are provided with a method to authenticate the consumer and validate the transaction, thus, allowing consumer purchases directly from their WEB site. Verification of a valid account number, account status, and customer authentication prior to completing a WEB transaction will reduce the number of WEB returns, thereby reducing operational costs. Additionally, the account-owner verification database according to the present invention will enable better acceptance of E-Check payments, thus benefiting Internet Banks, third parties and retailers.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of populating an account-owner verification database comprising:
(a) collecting participant data elements from one or more participant institutions, the participant data elements associated with one or more participant accounts in the participant institutions, and each participant data element also corresponding to a data element field in the database;
(b) collecting non-participant data elements from one or more non-participant institutions, the non-participant data elements associated with one or more non-participant accounts in the non-participant institutions, and each non-participant data element also corresponding to one of the data element fields in the database; and
(c) populating the data element fields of the account verification database with the collected participant and non-participant data elements.

2. The method of claim 1 further comprising the step of:
(d) automatically and periodically updating the data element fields in the database with participant data elements from recently opened or recently maintained accounts in the participant institutions.

3. The method of claim 1 wherein step (c) further comprises organizing the participant and non-participant data elements according to account number.

4. The method of claim 3 wherein step (c) further comprises organizing the account numbers and their associated participant and non-participant data elements according to routing transit number.

5. The method of claim 1 wherein step (b) further comprises extracting data elements from check images.

6. The method of claim 1 wherein step (b) further comprises extracting data elements from check printing data.

7. An account-owner verification database comprising:
a plurality of data element fields populated with participant data elements and non-participant data elements, wherein
the participant data elements are collected from one or more participant institutions and the participant data elements are associated with one or more participant accounts in the participant institutions; and
the non-participant data elements are collected from one or more non-participant institutions and the non-participant data elements are associated with one or more non-participant accounts in the non-participant institutions.

8. The account verification database of claim 7 wherein the data element fields are automatically and periodically updated with participant data elements from recently opened or recently maintained accounts in the participant institutions.

9. The account verification database of claim 7 wherein the participant and non-participant data elements are organized in the data element fields according to account number.

10. The account verification database of claim 9 wherein the account numbers and their associated participant and non-participant data elements are organized in the data element fields according to routing transit number.

11. The account verification database of claim 7 wherein the data elements are extracted from check images.

12. The account verification database of claim 7 wherein the data elements are extracted from check printing data.

13. A method of verifying information associated with transacting on an account, the method comprising:
(a) providing an account verification database, the database including account data corresponding to a plurality of data element fields and organized according to account number, the account data being obtained from participant and non-participant institutions;
(b) entering, for an account to be verified:
(i) an account number; and
(ii) at least one data element corresponding to the entered account number;
(c) querying the account verification database; and
(d) receiving a response from the database for each of the entered data elements, wherein the response corresponding to each entered data element is positive if the account data stored in the data element field corresponding to the entered account number matches the entered data element, respectively.

14. The method of claim 13 further comprising the step of:
(e) receiving a negative response from the database corresponding to each entered data element if the account data stored in the data element field corresponding to the entered account number does not match the entered data element, respectively.

15. The method of claim 14 further comprising the step of:
(f) generating a report to the participant institution associated with the entered account number that the data element resulted in a negative response.

16. The method of claim 13 further comprising the step of:
(e) receiving a neutral response from the database corresponding to each entered data element if the data element field corresponding to the entered account number does not contain any account data for the entered data element, respectively.

17. The method of claim 13 wherein step (a) further comprises entering a routing transit number corresponding to the entered account number.
